(19) United States
(12) Patent Application Publication
(10) Pub. No.: US 2026/0011045 A1
(43) Pub. Date: Jan. 8, 2026

(54) LARGE MODEL-BASED VISUAL CONTENT GENERATION AND TARGET LARGE MODEL TRAINING METHODS

(71) Applicant: BEIJING BAIDU NETCOM SCIENCE TECHNOLOGY CO., LTD., Beijing (CN)

(72) Inventors: Shuohuan WANG, Beijing (CN); Zhenyu ZHANG, Beijing (CN); Junyuan SHANG, Beijing (CN); Yu SUN, Beijing (CN); Hua WU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 19/326,273

(22) Filed: Sep. 11, 2025

(30) Foreign Application Priority Data
Jun. 3, 2025 (CN) 202510734116.6

(51) Int. Cl. G06T 11/00; G06V 10/74

(52) U.S. Cl. CPC G06T 11/00; G06V 10/761

(57) ABSTRACT

Large model-based visual content generation and target large model training methods, relating to artificial intelligence fields such as deep learning, a large model, computer vision and natural language processing, are provided. A large model-based visual content generation method may include: obtaining target instruction information; inputting the target instruction information into a target large model to obtain and output corresponding target result information, where the target result information includes target visual content, the target result information is generated by the target large model according to target thinking information, and the target thinking information is thinking process information generated by the target large model for the target instruction information.

### CROSS-REFERENCE TO RELATED APPLICATION

The present disclosure claims the priority and benefit of Chinese Patent Application No. 202510734116.6, filed on Jun. 3, 2025. The disclosure of the above application is incorporated herein by reference in its entirety.

### TECHNICAL FIELD

The present disclosure relates to the field of artificial intelligence technology, particularly to fields such as deep learning, large models, computer vision and natural language processing, and more particularly to large model-based visual content generation and target large model training methods.

### BACKGROUND

A large model refers to a deep learning model trained using large amounts of text data, which can generate natural language text or understand the meaning of natural language text, and can simulate a human language cognition and generation processes to some extent. Currently, large models have been widely applied in different scenarios, such as visual content generation. Visual content generation refers to generating corresponding visual content using the large model based on instruction information input by a user, where the visual content may be images or videos.

### SUMMARY

The present disclosure provides large model-based visual content generation and target large model training methods.

A large model-based visual content generation method, including:
obtaining target instruction information;
inputting the target instruction information into a target large model to obtain and output corresponding target result information, where the target result information includes target visual content, the target result information is generated by the target large model according to target thinking information, and the target thinking information is thinking process information generated by the target large model for the target instruction information.

A target large model training method, including:
obtaining a pre-trained base large model;
obtaining first training data, where the first training data includes: first sample instruction information, first sample result information corresponding to the first sample instruction information, and first sample thinking information, where the first sample thinking information is thinking process information generated for the first sample instruction information, and the first sample result information includes first visual content;
training the base large model according to the first training data, and determining the target large model according to training results.

An electronic device, including:
at least one processor; and
a memory communicatively connected to the at least one processor; where,
the memory stores instructions executable by the at least one processor to cause the at least one processor to perform the method as described above.

A non-transitory computer-readable storage medium storing computer instructions, where the computer instructions are used to cause a computer to perform the method as described above.

It should be understood that the content described in this section is not intended to identify key or essential features of the embodiments of the present disclosure, nor is it intended to limit the scope of the present disclosure. Other features of the present disclosure will become readily apparent through the following specification.

### BRIEF DESCRIPTION OF THE DRAWINGS

The drawings are used for better understanding the present solution and do not constitute a limitation of the present disclosure. In the drawings,

FIG. 1 is a flowchart of a large model-based visual content generation method according to an embodiment of the present disclosure;

FIG. 2 is a schematic diagram of interaction between a user and a target large model according to the present disclosure;

FIG. 3 is a schematic diagram of a first large model-based visual content generation process according to the present disclosure;

FIG. 4 is a schematic diagram of a second large model-based visual content generation process according to the present disclosure;

FIG. 5 is a flowchart of a target large model training method according to a first embodiment of the present disclosure;

FIG. 6 is a flowchart of a target large model training method according to a second embodiment of the present disclosure;

FIG. 7 is a structural schematic diagram of a large model-based visual content generation apparatus 700 according to an embodiment of the present disclosure;

FIG. 8 is a structural schematic diagram of a target large model training apparatus 800 according to an embodiment of the present disclosure; and

FIG. 9 shows a schematic block diagram of an electronic device 900 that can be used to implement embodiments of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

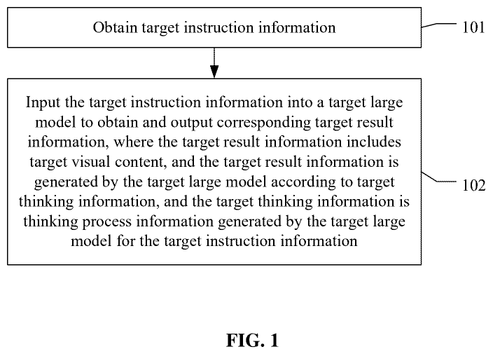

FIG. 1 is a flowchart of a large model-based visual content generation method according to an embodiment of the present disclosure. As shown in FIG. 1, the method includes the following specific implementation steps.

In step 101, obtain target instruction information (query).

In step 102, input the target instruction information into a target large model to obtain and output corresponding target result information, where the target result information includes target visual content, and the target result information is generated by the target large model according to target thinking information, and the target thinking information is thinking process information generated by the target large model for the target instruction information.

Currently, although a large model can be used to generate visual content corresponding to instruction information input by a user, the generated visual content usually has poor quality and cannot well meet user requirements.

By adopting the solution described in the above method embodiment, for a target large model, a thinking stage is explicitly added for target instruction information input by the user, that is, thinking process information can first be generated for the target instruction information, and then the required target result information can be generated based on the thinking process information, thereby improving the accuracy of the generated target result information and enabling the target result information to better meet user requirements.

In some embodiments of the present disclosure, the target large model may include: a multimodal large model, and the target instruction information may include: first generation requirement description information, or, the first generation requirement description information and a first image corresponding to the first generation requirement description information.

A multimodal large model is a model architecture that can simultaneously process input and output of multimodal data (such as text, images, audio, video, etc.) and achieve cross-modal understanding and generation. Its core objective is to integrate understanding and generation capabilities in traditional multimodal large models through a unified framework, thereby improving task generalization efficiency and interaction flexibility. The solution of the present disclosure can use a multimodal large model as the target large model, thereby further improving the accuracy of the generated target result information.

The target instruction information may only include first generation requirement description information (such as for text-to-image tasks), or may simultaneously include first generation requirement description information and a first image corresponding to the first generation requirement description information (such as for image editing tasks). That is, the target instruction information may only include text information, or may simultaneously include both text information and image information, which is very flexible and convenient.

Accordingly, the visual content generation process of the present disclosure can be divided into three stages: instruction obtaining stage, thinking stage, and response stage. The instruction obtaining stage refers to the stage of obtaining target instruction information input by users, the thinking stage refers to the internal thinking process stage of the target large model for the target instruction information, and the response stage refers to the stage of generating and outputting target result information.

The target result information may include target visual content, which may be an image or a video.

In some embodiments of the present disclosure, the target result information may also include: response text matching the target instruction information. Additionally, the target thinking information may be output while outputting the target result information.

In other words, while generating the target visual content, response text matching the target instruction information may also be generated to enrich the information content returned to users and improve the fluency of interaction between a user and the target large model. Furthermore, the target thinking information may be returned to the user to further enrich the information content returned to the user.

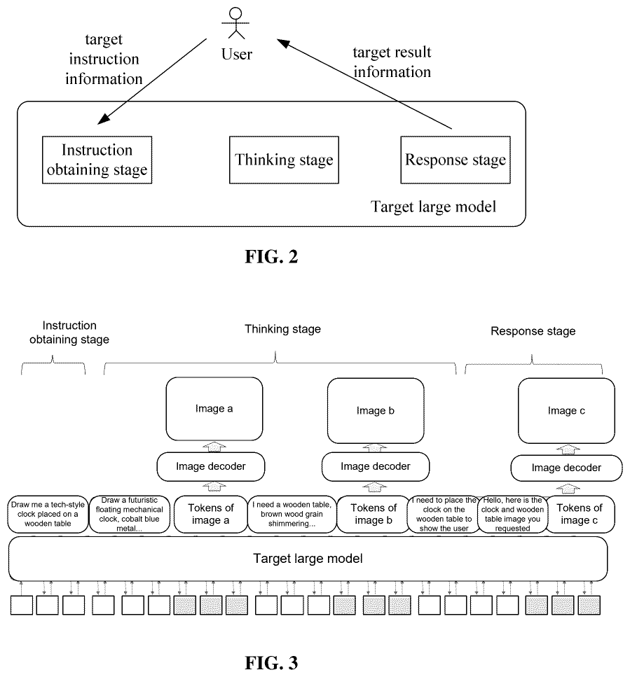

Accordingly, FIG. 2 is a schematic diagram of interaction between a user and a target large model according to the present disclosure. As shown in FIG. 2, a user may input target instruction information to the target large model, and the target large model can sequentially execute the instruction obtaining stage, thinking stage, and response stage, and can return target result information to the user. The target result information may include target visual content and response text matching the target instruction information.

Additionally, FIG. 3 is a schematic diagram of a first large model-based visual content generation process according to the present disclosure. As shown in FIG. 3, assuming the target instruction information only includes first generation requirement description information, which specifically is: “Draw me a tech-style clock placed on a wooden table,” the target large model can generate tokens from left to right, as shown in the bottom layer of FIG. 3 where a white block represents a text token, and a gray block represents an image token. Whether to generate a text token or an image token is determined by the target large model itself. For example, the target large model may first generate text content like “Draw a futuristic floating mechanical clock, cobalt blue metal . . . ” and generate a corresponding image a. Specifically, it can first generate tokens for image a, then use the Image Decoder to generate image a based on the tokens. Further, it can generate text content like “I need a wooden table, brown wood grain shimmering . . . ” and generate corresponding image b, then generate text content like “I need to place the clock on the wooden table to show the user” and generate corresponding image c, where image c is the target visual content. Additionally, it can simultaneously generate text content like “Hello, here is the clock and wooden table image you requested” as the response text.

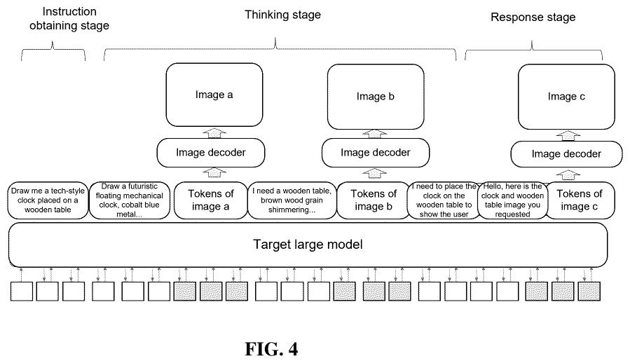

FIG. 4 is a schematic diagram of a second large model-based visual content generation process according to the present disclosure. As shown in FIG. 4, assuming the target instruction information includes both first generation requirement description information and a corresponding first image, where the first generation requirement description information specifically is: “Add a banana next to the apple in this image,” and the first image is “this image” mentioned in the first generation requirement description information. The tokens of the first image can be obtained through an Image Encoder. The target large model may first generate text content like “I need to draw a banana first” and generate corresponding image a′, then generate text content like “The banana's not good, draw another one” and generate corresponding image b′, then generate text content like “I will add the banana to the original image” and generate corresponding image c′, where image c′ is the target visual content. Additionally, it can simultaneously generate text content like “The banana has been added, any other requests?” as the response text.

The target large model can be obtained through pre-training. The following explains the training process of the target large model.

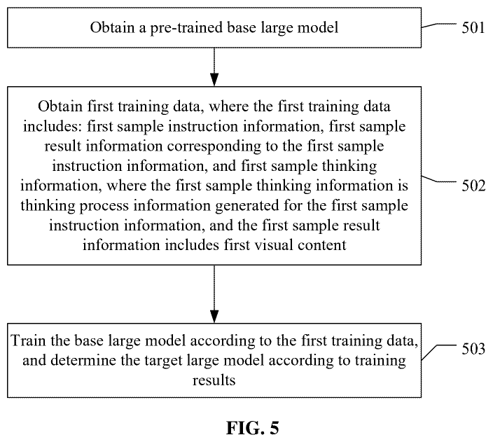

FIG. 5 is a flowchart of a target large model training method according to a first embodiment of the present disclosure. As shown in FIG. 5, it includes the following specific implementation methods.

In step 501, obtain a pre-trained base large model.

In step 502, obtain first training data, where the first training data includes: first sample instruction information, first sample result information corresponding to the first sample instruction information, and first sample thinking information, where the first sample thinking information is thinking process information generated for the first sample instruction information, and the first sample result information includes first visual content.

In step 503, train the base large model according to the first training data, and determine the target large model according to training results.

Based on the above training data, the target large model can learn how to generate thinking process information to generate target result information corresponding to user input target instruction information based on the thinking process information, thereby improving the accuracy of the generated target result information and enabling the target result information to better meet user requirements.

In some embodiments of the present disclosure, the target large model may include: a multimodal large model. Accordingly, the base large model can be a multimodal large model, such as directly reusing an existing pre-trained multimodal large model like a multimodal foundation model (Chameleon), thereby improving training efficiency and leveraging the powerful reasoning capability of the multimodal large model to improve the accuracy of the obtained target result information.

There are no restrictions on how to obtain the first training data; for example, the first training data may be manually collected and annotated. The first training data may include: first sample instruction information, first sample result information, and first sample thinking information, where the first sample thinking information is thinking process information generated for the first sample instruction information, and the first sample result information includes first visual content.

That is, the first training data may include: <query> . . . </query><thinking> . . . </thinking><response> . . . </response>, where <query> . . . </query> represents first sample instruction information, <thinking> . . . </thinking> represents first sample thinking information, and <response> . . . </response> represents first sample result information.

In some embodiments of the present disclosure, the first sample instruction information may include: second generation requirement description information, or, second generation requirement description information and a second image corresponding to the second generation requirement description information. Accordingly, any first sample thinking information may include one of the following: 1) refined requirement description information obtained by refining the second generation requirement description information; 2) step description information for generating the first sample result information; 3) initial result information and optimization description information, where the first sample result information is obtained by performing optimization processing corresponding to the optimization description information on the initial result information; 4) M candidate result information corresponding to the first sample instruction information and selection reason information, where M is a positive integer greater than 1, the M candidate result information includes the first sample result information, and the selection reason information is used to explain reasons why the first sample result information is superior to other candidate result information.

That is, at least the above four methods may be used to generate thinking process information. Taking the first visual content as an image as an example, the four methods are further explained below.

In method 1), text can be used to enrich and rewrite the first sample instruction information, that is, refining the second generation requirement description information to obtain refined requirement description information. Compared with the second generation requirement description information, the refined requirement description information can improve details, style, layout, etc. of the image to be generated.

In method 2), the second generation requirement description information can be broken down to obtain step description information for generating the first sample result information, such as which text content to generate first, which image to generate next, . . . , and finally how to combine to get the final required image.

In method 3), the generated image content can be repeatedly modified. For example, initial result information and optimization description information (text reflection information) can be provided. The image in the first sample result information can be obtained by performing optimization processing corresponding to the optimization description information on the image in the initial result information, that is, the optimization description information can be used to make detailed modifications to the image in the initial result information to obtain the image in the first sample result information.

In method 4), M candidate result information corresponding to the first sample instruction information can be provided simultaneously, where M is a positive integer greater than 1, and the specific value can be determined according to actual needs. Selection reason information can also be provided. The M candidate result information includes the first sample result information, and the selection reason information is used to explain why the first sample result information is superior to other candidate result information, that is, the selection reason information is used to explain why the first sample result information is selected from the M candidate result information as the final required result.

It can be seen that through the above processing, the target large model can learn various different ways of thinking, thereby improving the learning effect of the target large model, that is, improving the performance of the target large model. Subsequently, when using the target large model for actual inference applications, the target large model can decide the specific thinking process information by itself.

In some embodiments of the present disclosure, when training the base large model according to the first training data, autoregressive training can be performed on the base large model using maximum likelihood estimation according to the first training data.

Maximum likelihood estimation is a mature training method. Accordingly, maximum likelihood estimation can be used to perform autoregressive training on the base large model according to the process of first sample instruction information, first sample thinking information and first sample result information, thereby improving the training efficiency and learning effect of the target large model.

After training the base large model according to the first training data, the target large model can be determined according to the training results.

In some embodiments of the present disclosure, after training the base large model according to the first training data, an intermediate large model can be obtained. Then, the intermediate large model can be directly determined as the target large model, or second training data can be obtained. The second training data may include: second sample instruction information, and reinforcement learning training can be performed on the intermediate large model according to the second training data to obtain the target large model.

Training the base large model according to the first training data refers to performing Supervised Fine-Tuning (SFT) training on the base large model. Since the base large model is obtained through pre-training, the required target large model can be obtained through the combination of pre-training and fine-tuning. Alternatively, to further improve the performance of the target large model, after obtaining the intermediate large model, reinforcement learning training can be performed using the second training data.

Specifically, the reinforcement learning can use algorithms such as Reinforcement Learning from Human Feedback (RLHF).

In some embodiments of the present disclosure, the method of performing reinforcement learning training on the intermediate large model according to the second training data may include: inputting the second sample instruction information into the intermediate large model to obtain output intermediate result information, where the intermediate result information includes second visual content, determining a comprehensive evaluation result according to the intermediate result information and the second sample instruction information, and updating the intermediate large model according to the principle of improving the comprehensive evaluation result.

The comprehensive evaluation result can refer to a comprehensive score, that is, the reward model's comprehensive score. The optimization goal of reinforcement learning is to improve the comprehensive score of the output result. Accordingly, after determining the comprehensive score according to the intermediate result information and the second sample instruction information, the intermediate large model can be updated (i.e., optimized) according to the principle of improving the comprehensive score.

In some embodiments of the present disclosure, the second sample instruction information may include: third generation requirement description information, or, third generation requirement description information and a third image corresponding to the third generation requirement description information. Accordingly, in response to the second visual content being an image, the method of determining the comprehensive evaluation result according to the intermediate result information and the second sample instruction information may include: obtaining a similarity score between the second visual content and the third generation requirement description information, and obtaining an aesthetic score of the second visual content. In response to determining that the second sample instruction information does not include the third image, determining the comprehensive score according to the similarity score and the aesthetic score. In response to determining that the second sample instruction information includes the third image, obtaining a sum of squares of differences between corresponding pixel points in the second visual content and the third image, where the corresponding pixel points are pixel points with same coordinate positions, and determining the comprehensive score according to the similarity score, the aesthetic score and the sum of squares.

That is, the solution of the present disclosure can adopt a multi-objective reinforcement learning approach that includes both model scoring and rule calculation. Model scoring refers to the aforementioned similarity score and aesthetic score. For example, a pre-trained text-image similarity model can be used to determine the similarity score between the second visual content and the third generation requirement description information, and a pre-trained image aesthetic evaluation model can be used to determine the aesthetic score of the second visual content. Rule calculation refers to calculating the sum of squares of differences between corresponding pixel points (differences of individual pixel points) in the second visual content and the third image. The similarity score reflects the degree to which the target large model follows the user's instruction—the higher the similarity score, the higher the degree to which the target large model follows the user's instruction. The aesthetic score reflects the aesthetic quality of the generated second visual content—the higher the aesthetic score, the better the aesthetic quality of the second visual content will be. The sum of squares reflects whether the original image was followed during the image editing process—the larger the sum of squares value, the higher the degree of adherence. Accordingly, determining the comprehensive score by combining the similarity score, aesthetic score, and sum of squares can improve the accuracy of the obtained comprehensive score, thereby improving the optimization efficiency of the intermediate large model.

There are no restrictions on how to determine the comprehensive score by combining the similarity score, aesthetic score, and sum of squares. For example, the comprehensive score can be calculated according to a predetermined calculation formula.

Combining the above introduction, FIG. 6 is a flowchart of a target large model training method according to a second embodiment of the present disclosure. As shown in FIG. 6, it includes the following specific implementation methods.

In step 601, obtain a pre-trained base large model.

The base large model can be a multimodal large model.

In step 602, obtain first training data, which includes: first sample instruction information, first sample result information corresponding to the first sample instruction information, and first sample thinking information, where the first sample thinking information is thinking process information generated for the first sample instruction information, and the first sample result information includes first visual content.

The first sample instruction information may include: second generation requirement description information, or, second generation requirement description information and a second image corresponding to the second generation requirement description information.

Additionally, any first sample thinking information may include one of the following: refined requirement description information obtained by refining the second generation requirement description information; step description information for generating the first sample result information; initial result information and optimization description information, where the first sample result information is obtained by performing optimization processing corresponding to the optimization description information on the initial result information; M candidate result information corresponding to the first sample instruction information and selection reason information, where M is a positive integer greater than 1, the M candidate result information includes the first sample result information, and the selection reason information is used to explain reasons why the first sample result information is superior to other candidate result information.

In step 603, train the base large model according to the first training data to obtain an intermediate large model.

For example, autoregressive training can be performed on the base large model using maximum likelihood estimation according to the first training data.

In step 604, obtain second training data, where the second training data includes: second sample instruction information.

The second sample instruction information includes: third generation requirement description information, or, third generation requirement description information and a third image corresponding to the third generation requirement description information.

In step 605, perform reinforcement learning training on the intermediate large model according to the second training data to obtain the target large model.

For example, input the second sample instruction information into the intermediate large model to obtain output intermediate result information, where the intermediate result information includes second visual content, then determine a comprehensive evaluation result according to the intermediate result information and the second sample instruction information, and further update the intermediate large model according to the principle of improving the comprehensive evaluation result.

After obtaining the target large model, the target large model can be applied to actual inference applications, for example, applied to the visual content generation method shown in FIG. 1, for generating corresponding target result information based on input target instruction information.

Additionally, during the inference application process, after using the target large model to generate target result information, the target result information and corresponding target instruction information can be used to perform further reinforcement learning training on the target large model to further improve its performance.

It should be noted that for the preceding method embodiments, for simple description, they are all expressed as a series of action combinations. However, those skilled in the art should know that the present disclosure is not limited by the described action sequence, because according to the present disclosure, some steps can be performed in other orders or simultaneously. Secondly, those skilled in the art should also know that the embodiments described in the specification are all preferred embodiments, and the actions and modules involved are not necessarily essential to the present disclosure. Additionally, for parts not detailed in one embodiment, reference can be made to relevant descriptions in other embodiments.

The above is an introduction to the method embodiments. The following further explains the solution of the present disclosure through embodiments of apparatus.

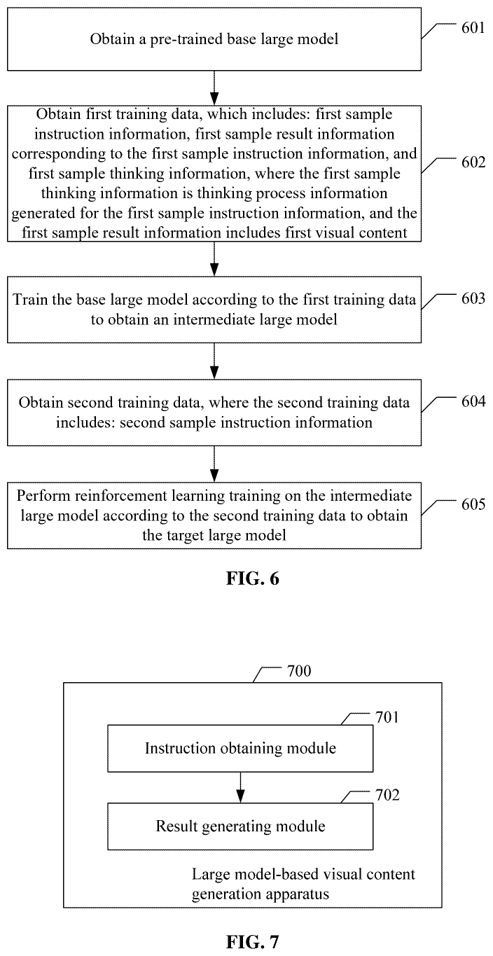

FIG. 7 is a structural schematic diagram of a large model-based visual content generation apparatus 700 according to an embodiment of the present disclosure. As shown in FIG. 7, the apparatus includes: an instruction obtaining module 701 and a result generating module 702.

The instruction obtaining module 701 is configured to obtain target instruction information.

The result generating module 702 is configured to input the target instruction information into a target large model to obtain and output corresponding target result information, where the target result information includes target visual content, the target result information is generated by the target large model according to target thinking information, and the target thinking information is thinking process information generated by the target large model for the target instruction information.

In some embodiments of the present disclosure, the target large model may include: a multimodal large model, and the target instruction information may include:

first generation requirement description information, or, first generation requirement description information and a first image corresponding to the first generation requirement description information.

In some embodiments of the present disclosure, the target result information may also include: response text matching the target instruction information, and/or, the result generating module 702 may also output the target thinking information while outputting the target result information.

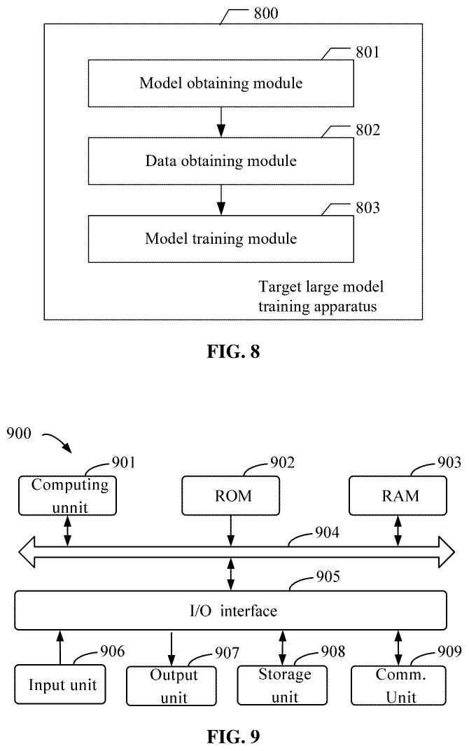

FIG. 8 shows a structural schematic diagram of a target large model training apparatus 800 according to an embodiment of the present disclosure. As shown in FIG. 8, the apparatus includes: a model obtaining module 801, a data obtaining module 802, and a model training module 803.

The model obtaining module 801 is configured to obtain a pre-trained base large model.

The data obtaining module 802 is configured to obtain first training data which includes: first sample instruction information, first sample result information corresponding to the first sample instruction information, and first sample thinking information, where the first sample thinking information is thinking process information generated for the first sample instruction information, and the first sample result information includes first visual content.

The model training module 803 is configured to train the base large model according to the first training data, and determine the target large model according to training results.

In some embodiments of the present disclosure, the target large model may include: a multimodal large model; the first sample instruction information includes: second generation requirement description information, or, second generation requirement description information and a second image corresponding to the second generation requirement description information.

In some embodiments of the present disclosure, any first sample thinking information may include one of the following: refined requirement description information obtained by refining the second generation requirement description information; step description information for generating the first sample result information; initial result information and optimization description information, where the first sample result information is obtained by performing optimization processing corresponding to the optimization description information on the initial result information; M candidate result information corresponding to the first sample instruction information and selection reason information, where M is a positive integer greater than 1, the M candidate result information includes the first sample result information, and the selection reason information is used to explain reasons why the first sample result information is superior to other candidate result information.

In some embodiments of the present disclosure, when the model training module 803 trains the base large model according to the first training data, it can perform autoregressive training on the base large model using maximum likelihood estimation according to the first training data.

In some embodiments of the present disclosure, after the model training module 803 trains the base large model according to the first training data, it can obtain an intermediate large model. Then, it can directly determine the intermediate large model as the target large model, or obtain second training data, where the second training data includes: second sample instruction information, and perform reinforcement learning training on the intermediate large model according to the second training data to obtain the target large model.

In some embodiments of the present disclosure, the method of the model training module 803 performing reinforcement learning training on the intermediate large model according to the second training data may include: inputting the second sample instruction information into the intermediate large model to obtain output intermediate result information, where the intermediate result information includes second visual content, determining a comprehensive evaluation result according to the intermediate result information and the second sample instruction information, and updating the intermediate large model according to the principle of improving the comprehensive evaluation result.

In some embodiments of the present disclosure, the second sample instruction information may include: third generation requirement description information, or, third generation requirement description information and a third image corresponding to the third generation requirement description information; the comprehensive evaluation result may include: a comprehensive score. Accordingly, in response to the second visual content being an image, the method of the model training module 803 determining the comprehensive evaluation result according to the intermediate result information and the second sample instruction information may include: obtaining a similarity score between the second visual content and the third generation requirement description information, and obtaining an aesthetic score of the second visual content. In response to determining that the second sample instruction information does not include the third image, determining the comprehensive score according to the similarity score and the aesthetic score. In response to determining that the second sample instruction information includes the third image, obtaining a sum of squares of differences between corresponding pixel points in the second visual content and the third image, where the corresponding pixel points are pixel points with same coordinate positions, and determining the comprehensive score according to the similarity score, the aesthetic score and the sum of squares.

The specific work flow of each embodiment of the apparatus above can refer to the relevant descriptions in the previous embodiment of the method and will not be repeated here.

In summary, by adopting the solution described in the present disclosure, the chain-of-thought technology of a multimodal large model can be utilized to improve the accuracy of a visual content generation result, and it can be applied to different visual content generation scenarios with broad applicability.

The solution described in the present disclosure can be applied in the field of artificial intelligence, particularly in the fields such as deep learning, large models, computer vision and natural language processing. Artificial intelligence is a discipline that studies how to make computers simulate certain human thinking processes and intelligent behaviors (such as learning, reasoning, thinking, planning, etc.). It involves both hardware and software technologies. Artificial intelligence hardware technology generally includes technologies such as sensors, specialized AI chips, cloud computing, distributed storage, big data processing, etc. Artificial intelligence software technology mainly includes several major directions such as computer vision technology, speech recognition technology, natural language processing technology, machine learning/deep learning, big data processing technology, and knowledge graph technology.

Additionally, the instruction information and result information mentioned in the embodiments of the present disclosure are not specific to any particular user and cannot reflect personal information of any particular user. In the technical solutions of the present disclosure, the collection, storage, use, processing, transmission, provision and disclosure of user personal information comply with relevant laws and regulations and do not violate public order and good morals.

According to the embodiment of the present disclosure, there are also provided an electronic device, a readable storage medium and a computer program product.

FIG. 9 shows a schematic block diagram of an electronic device 900 which may be configured to implement the embodiment of the present disclosure. The electronic device is intended to represent various forms of digital computers, such as laptop computers, desktop computers, workstations, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 9, the device 900 includes a computing unit 901 which may perform various appropriate actions and processing operations according to a computer program stored in a read only memory (ROM) 902 or a computer program loaded from a storage unit 908 into a random access memory (RAM) 903. Various programs and data necessary for the operation of the device 900 may be also stored in the RAM 903. The computing unit 901, the ROM 902, and the RAM 903 are connected with one other through a bus 904. An input/output (I/O) interface 905 is also connected to the bus 904.

The plural components in the device 900 are connected to the I/O interface 905, and include: an input unit 906, such as a keyboard, a mouse, or the like; an output unit 907, such as various types of displays, speakers, or the like; the storage unit 908, such as a magnetic disk, an optical disk, or the like; and a communication unit 909, such as a network card, a modem, a wireless communication transceiver, or the like. The communication unit 909 allows the device 900 to exchange information/data with other devices through a computer network, such as the Internet, and/or various telecommunication networks.

The computing unit 901 may be a variety of general and/or special purpose processing components with processing and computing capabilities. Some examples of the computing unit 901 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 901 performs the methods and processing operations described above, such as the method according to the present disclosure. For example, in some embodiments, the method according to the present disclosure may be implemented as a computer software program tangibly contained in a machine readable medium, such as the storage unit 908. In some embodiments, part or all of the computer program may be loaded and/or installed into the device 900 via the ROM 902 and/or the communication unit 909. When the computer program is loaded into the RAM 903 and executed by the computing unit 901, one or more steps of the method according to the present disclosure may be performed. Alternatively, in other embodiments, the computing unit 901 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A large model-based visual content generation method, comprising:
obtaining target instruction information;
inputting the target instruction information into a target large model to obtain and output corresponding target result information, wherein the target result information includes target visual content, the target result information is generated by the target large model according to target thinking information, and the target thinking information is thinking process information generated by the target large model for the target instruction information.

2. The method according to claim 1, wherein,
the target large model comprises: a multimodal large model;
the target instruction information includes: first generation requirement description information.

3. The method according to claim 2, wherein the target instruction information includes a first image corresponding to the first generation requirement description information.

4. The method according to claim 1, wherein,
the target result information further includes: response text matching the target instruction information.

5. The method according to claim 1, further comprising: outputting the target thinking information while outputting the target result information.

6. A target large model training method, comprising:
obtaining a pre-trained base large model;
obtaining first training data, wherein the first training data includes: first sample instruction information, first sample result information corresponding to the first sample instruction information, and first sample thinking information, wherein the first sample thinking information is thinking process information generated for the first sample instruction information, and the first sample result information includes first visual content; and
training the base large model according to the first training data, and determining a target large model according to the training results.

7. The method according to claim 6, wherein,
the target large model comprises: a multimodal large model;
the first sample instruction information includes: second generation requirement description information.

8. The method according to claim 7, wherein the first sample instruction information further includes: a second image corresponding to the second generation requirement description information.

9. The method according to claim 7, wherein,
any of the first sample thinking information includes one of the following:
refined requirement description information obtained by refining the second generation requirement description information;
step description information for generating the first sample result information;
initial result information and optimization description information, wherein the first sample result information is obtained by performing optimization processing corresponding to the optimization description information on the initial result information; and
M candidate result information corresponding to the first sample instruction information and selection reason information, wherein M is a positive integer greater than 1, the M candidate result information includes the first sample result information, and the selection reason information is used to explain reasons why the first sample result information is superior to other candidate result information.

10. The method according to claim 6, wherein training the base large model according to the first training data comprises:
performing autoregressive training on the base large model using maximum likelihood estimation according to the first training data.

11. The method according to claim 6, wherein training the base large model according to the first training data and determining the target large model according to training results comprises:
training the base large model according to the first training data to obtain an intermediate large model;
determining the intermediate large model as the target large model, or, obtaining second training data, wherein the second training data includes: second sample instruction information, and performing reinforcement learning training on the intermediate large model according to the second training data to obtain the target large model.

12. The method according to claim 11, wherein performing reinforcement learning training on the intermediate large model according to the second training data comprises:
inputting the second sample instruction information into the intermediate large model to obtain output intermediate result information, wherein the intermediate result information includes second visual content;
determining a comprehensive evaluation result according to the intermediate result information and the second sample instruction information; and
updating the intermediate large model according to a principle of improving the comprehensive evaluation result.

13. The method according to claim 12, wherein,
the second sample instruction information includes: third generation requirement description information, or, the third generation requirement description information and a third image corresponding to the third generation requirement description information;
the comprehensive evaluation result includes: a comprehensive score;
in response to determining that the second visual content is an image, determining the comprehensive evaluation result according to the intermediate result information and the second sample instruction information comprises:
obtaining a similarity score between the second visual content and the third generation requirement description information, and obtaining an aesthetic score of the second visual content;
in response to determining that the second sample instruction information does not include the third image, determining the comprehensive score according to the similarity score and the aesthetic score;
in response to determining that the second sample instruction information includes the third image, obtaining a sum of squares of differences between corresponding pixel points in the second visual content and the third image, wherein the corresponding pixel points are pixel points with same coordinate positions, and determining the comprehensive score according to the similarity score, the aesthetic score and the sum of squares.

14. An electronic device, comprising:
at least one processor; and
a memory communicatively connected to the at least one processor; wherein,
the memory stores instructions executable by the at least one processor, the instructions when executed by the at least one processor, cause the at least one processor to perform a target large model training method, comprising:
obtaining a base large model;
obtaining first training data, wherein the first training data includes: first sample instruction information, first sample result information corresponding to the first sample instruction information, and first sample thinking information, wherein the first sample thinking information is thinking process information generated for the first sample instruction information, and the first sample result information includes first visual content;
training the base large model according to the first training data, and determining a target large model according to the training results.

15. The electronic device according to claim 14, wherein,
the target large model comprises: a multimodal large model;
the first sample instruction information includes: second generation requirement description information.

16. The electronic device according to claim 15, wherein,
any of the first sample thinking information includes one of the following:
refined requirement description information obtained by refining the second generation requirement description information;
step description information for generating the first sample result information;
initial result information and optimization description information, wherein the first sample result information is obtained by performing optimization processing corresponding to the optimization description information on the initial result information; and
M candidate result information corresponding to the first sample instruction information and selection reason information, wherein M is a positive integer greater than 1, the M candidate result information includes the first sample result information, and the selection reason information is used to explain reasons why the first sample result information is superior to other candidate result information.

17. The electronic device according to claim 14, wherein training the base large model according to the first training data comprises:
performing autoregressive training on the base large model using maximum likelihood estimation according to the first training data.

18. The electronic device according to claim 14, wherein training the base large model according to the first training data and determining the target large model according to training results comprises:
training the base large model according to the first training data to obtain an intermediate large model;
determining the intermediate large model as the target large model, or, obtaining second training data, wherein the second training data includes: second sample instruction information, and performing reinforcement learning training on the intermediate large model according to the second training data to obtain the target large model.

19. The electronic device according to claim 18, wherein performing reinforcement learning training on the intermediate large model according to the second training data comprises:
inputting the second sample instruction information into the intermediate large model to obtain output intermediate result information, wherein the intermediate result information includes second visual content;
determining a comprehensive evaluation result according to the intermediate result information and the second sample instruction information; and
updating the intermediate large model according to a principle of improving the comprehensive evaluation result.

20. The electronic device according to claim 19, wherein,
the second sample instruction information includes: third generation requirement description information, or, the third generation requirement description information and a third image corresponding to the third generation requirement description information;
the comprehensive evaluation result includes: a comprehensive score;
in response to determining that the second visual content is an image, determining the comprehensive evaluation result according to the intermediate result information and the second sample instruction information comprises:
obtaining a similarity score between the second visual content and the third generation requirement description information, and obtaining an aesthetic score of the second visual content;
in response to determining that the second sample instruction information does not include the third image, determining the comprehensive score according to the similarity score and the aesthetic score;
in response to determining that the second sample instruction information includes the third image, obtaining a sum of squares of differences between corresponding pixel points in the second visual content and the third image, wherein the corresponding pixel points are pixel points with same coordinate positions, and determining the comprehensive score according to the similarity score, the aesthetic score and the sum of squares.
